(19) United States
(12) Patent Application Publication
(10) Pub. No.: US 2015/0381282 A1
(43) Pub. Date: Dec. 31, 2015

(54) POLARIZATION ASSISTED WIRELESS TRANSMISSION

(71) Applicant: QUALCOMM Incorporated, San Diego, CA (US)

(72) Inventors: Zhenliang Zhang, Somerset, NJ (US); Sundar Subramanian, Bridgewater, NJ (US); Andrzej Partyka, Bedminster, NJ (US); Ashwin Sampath, Skillman, NJ (US); Junyi Li, Chester, NJ (US)

(21) Appl. No.: 14/571,935

(22) Filed: Dec. 16, 2014

Related U.S. Application Data
(60) Provisional application No. 62/018,356, filed on Jun. 27, 2014.

(51) Int. Cl. H04B 10/532; H04W 72/04; H04W 24/10; H04L 5/00

(52) U.S. Cl. CPC H04B 10/532; H04L 5/0048; H04W 72/0453; H04W 72/0446; H04W 24/10

(57) ABSTRACT

Methods, systems, and devices are described for selecting a polarization mode. A transmitter may select a polarization mode from a plurality of polarization modes available for transmission. The transmitter may send transmission(s) based on the selected polarization mode. The transmitter may update the selected polarization mode in real time based on feedback signals received from a receiver receiving the transmissions. The transmitter may also provide for time frequency diversity in the transmissions using one or more polarization modes. Aspects of the time frequency diversity may also be updated in real time based on received feedback signals.

### CROSS REFERENCES

The present application for patent claims priority to U.S. Provisional Patent Application No. 62/018,356 by Zhang et al., entitled “Polarization Assisted Wireless Communications,” filed Jun. 27, 2014, assigned to the assignee hereof, and expressly incorporated by reference herein.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. It is advantageous to provide coverage enhancement in wireless communication systems, especially in systems where the receiver is highly signal strength and noise limited. In addition to traditional pathloss concerns, loss arises from mismatch between the electromagnetic wave and receiver antenna polarization. For polarization aligned communications, interactions with objects cause reflection, diffraction, and the like which introduce variations in the electromagnetic wave orientation and further loss in signal strength. Therefore, signal gain may be realized by polarization matching of the electromagnetic wave and the receiver antenna.

### SUMMARY

The described features generally relate to one or more improved systems, methods, and/or apparatuses for a transmitter to dynamically select a polarization mode for transmissions that increases the link signal-to-noise ratio (SNR). Generally, the transmitter may select a polarization mode from polarization modes available for transmission and send transmissions using the selected polarization mode. The selected polarization mode may enhance alignment of the received electromagnetic waves at the receive antenna to improve received signal strength. The transmitter may receive feedback from a receiver on a continuing basis during the transmission such that the transmitter may dynamically update the selected polarization mode in real time. The transmitter may, in some configuration, send training signals to the receivers to solicit feedback before the transmissions to select the polarization mode.

In a first set of illustrative examples, a method for wireless communications is provided. The method may include: transmitting a plurality of reference signals, each reference signal being transmitted at a different polarization mode; receiving a response associated with at least one of the transmitted reference signals; dynamically selecting a polarization mode from a plurality of polarization modes available for transmission based at least in part on the received response; and transmitting one or more transmissions based on the selected polarization mode.

In some aspects, the method may also include updating the selected polarization mode in real time based at least in part on feedback from a receiver receiving the transmissions. The received response may include information indicative of a received signal strength for the associated transmitted reference signal. The plurality of transmitted reference signals may be transmitted at a different transmit time. The plurality of transmitted reference signals may be transmitted at a different transmit frequency. The plurality of transmitted reference signals may be transmitted at a different transmit time and a different transmit frequency.

In some aspects, the method may also include: sub-dividing time frequency resources into a plurality of transmission opportunities, wherein at least a portion of the plurality of transmission opportunities are different size; and selecting a polarization mode for each transmission opportunity. The method may include adjusting the size of the plurality of transmission opportunities based at least in part on feedback received from a receiver receiving a transmission during one of the transmission opportunities, wherein the feedback comprises information indicative of the received signal strength of the transmission opportunities. In some cases, the plurality of transmission opportunities may comprise a portion of time, wherein the portion of time is a subset of the time frequency resources. In some cases, the plurality of transmission opportunities may comprise a portion of bandwidth, wherein the portion of bandwidth is a subset of the time frequency resources.

In some aspects, the method may include: accessing historical data associated with previous transmissions; and selecting the polarization mode based at least in part on the historical data. The historical data may include information associated with received signal strength measurements for the previous transmissions. Selecting the polarization mode may include selecting a different polarization mode for each transmission such that the transmissions are transmitted in a circularly polarized scheme. The transmission may be a millimeter wave transmission.

In a second set of illustrative examples, an apparatus for wireless communications is provided. The apparatus may include: a processor; memory in electronic communication with the processor; and instructions stored in the memory, the instructions being executable by the processor to: transmit a plurality of reference signals, each reference signal being transmitted at a different polarization mode; receive a response associated with at least one of the transmitted reference signals; dynamically select a polarization mode from a plurality of polarization modes available for transmission based at least in part on the received response; and transmit one or more transmissions based on the selected polarization mode.

In some aspects, the apparatus may include instructions executable by the processor to: update the selected polarization mode in real time based at least in part on feedback from a receiver receiving the transmissions. The received response may include information indicative of a received signal strength for the associated transmitted reference signal. The plurality of transmitted reference signals may be transmitted at a different transmit time. The plurality of transmitted reference signals may be transmitted at a different transmit frequency. The plurality of transmitted reference signals may be transmitted at a different transmit time and a different transmit frequency.

In some aspects, the apparatus may include instructions executable by the processor to: sub-divide time frequency resources into a plurality of transmission opportunities, wherein at least a portion of the plurality of transmission opportunities are different size; and select a polarization mode for each transmission opportunity. The apparatus may include instructions executable by the processor to: adjust the size of the plurality of transmission opportunities based at least in part on feedback received from a receiver receiving a transmission during one of the transmission opportunities, wherein the feedback comprises information indicative of the received signal strength of the transmission opportunities. In some cases, the plurality of transmission opportunities may comprise a portion of time, wherein the portion of time is a subset of the time frequency resources. In some cases, the plurality of transmission opportunities may comprise a portion of bandwidth, wherein the portion of bandwidth is a subset of the time frequency resources.

In some aspects, the apparatus may include instructions executable by the processor to: access historical data associated with previous transmissions; and select the polarization mode based at least in part on the historical data. The historical data may include information associated with received signal strength measurements for the previous transmissions.

In some aspects, the instructions executable by the processor to select the polarization mode may be further executable to: select a different polarization mode for each transmission such that the transmissions are transmitted in a circularly polarized scheme. The transmission may be a millimeter wave transmission.

In a third set of illustrative examples, an apparatus for wireless communications is provided. The apparatus may include: means for transmitting a plurality of reference signals, each reference signal being transmitted at a different polarization mode; means for receiving a response associated with at least one of the transmitted reference signals; dynamically selecting a polarization mode from a plurality of polarization modes available for transmission based at least in part on the received response; and means for transmitting one or more transmissions based on the selected polarization mode.

In some aspects, the apparatus may include means for: updating the selected polarization mode in real time based at least in part on feedback from a receiver receiving the transmissions. The received response may include information indicative of a received signal strength for the associated transmitted reference signal. The plurality of transmitted reference signals may be transmitted at a different transmit time. The plurality of transmitted reference signals may be transmitted at a different transmit frequency. The plurality of transmitted reference signals may be transmitted at a different transmit time and a different transmit frequency.

In some aspects, the apparatus may include means for: sub-dividing time frequency resources into a plurality of transmission opportunities, wherein at least a portion of the plurality of transmission opportunities are different size; and select a polarization mode for each transmission opportunity. The apparatus may include means for: adjusting the size of the plurality of transmission opportunities based at least in part on feedback received from a receiver receiving a transmission during one of the transmission opportunities, wherein the feedback comprises information indicative of the received signal strength of the transmission opportunities. In some cases, the plurality of transmission opportunities may comprise a portion of time, wherein the portion of time is a subset of the time frequency resources. In some cases, the plurality of transmission opportunities may comprise a portion of bandwidth, wherein the portion of bandwidth is a subset of the time frequency resources.

In some aspects, the apparatus may include means for: accessing historical data associated with previous transmissions; and selecting the polarization mode based at least in part on the historical data. The historical data may include information associated with received signal strength measurements for the previous transmissions.

In some aspects, the means for selecting the polarization mode may further include means for: selecting a different polarization mode for each transmission such that the transmissions are transmitted in a circularly polarized scheme. The transmission may be a millimeter wave transmission.

In a fourth set of illustrative examples, a computer-readable medium storing code for wireless communications is provided. The non-transitory computer-readable medium may store code for wireless communications, the code may comprise instructions executable to: transmit a plurality of reference signals, each reference signal being transmitted at a different polarization mode; receive a response associated with at least one of the transmitted reference signals; dynamically select a polarization mode from a plurality of polarization modes available for transmission based at least in part on the received response; and transmit one or more transmissions based on the selected polarization mode.

In some aspects, the computer-readable medium may include instructions to: update the selected polarization mode in real time based at least in part on feedback from a receiver receiving the transmissions. The received response may include information indicative of a received signal strength for the associated transmitted reference signal. The plurality of transmitted reference signals may be transmitted at a different transmit time. The plurality of transmitted reference signals may be transmitted at a different transmit frequency. The plurality of transmitted reference signals may be transmitted at a different transmit time and a different transmit frequency.

In some aspects, the computer-readable medium may include instructions to: sub-divide time frequency resources into a plurality of transmission opportunities, wherein at least a portion of the plurality of transmission opportunities are different size; and select a polarization mode for each transmission opportunity. The computer-readable medium may include instructions to: adjust the size of the plurality of transmission opportunities based at least in part on feedback received from a receiver receiving a transmission during one of the transmission opportunities, wherein the feedback comprises information indicative of the received signal strength of the transmission opportunities. In some cases, the plurality of transmission opportunities may comprise a portion of time, wherein the portion of time is a subset of the time frequency resources. In some cases, the plurality of transmission opportunities may comprise a portion of bandwidth, wherein the portion of bandwidth is a subset of the time frequency resources.

In some aspects, the computer-readable medium may include instructions to: access historical data associated with previous transmissions; and select the polarization mode based at least in part on the historical data. The historical data may include information associated with received signal strength measurements for the previous transmissions.

In some aspects, the instructions to select the polarization mode may further comprise instructions to: select a different polarization mode for each transmission such that the transmissions are transmitted in a circularly polarized scheme. The transmission may be a millimeter wave transmission.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of multiple wireless communications systems, in accordance with various aspects of the present disclosure;

FIG. 2 shows a block diagram of a wireless device for selecting a polarization mode in a wireless communication system, in accordance with various aspects of the present disclosure;

FIG. 3 shows a block diagram of a wireless device for selecting a polarization mode in a wireless communication system, in accordance with various aspects of the present disclosure;

FIG. 4 shows a block diagram of a wireless device for selecting a polarization mode in a wireless communication system, in accordance with various aspects of the present disclosure;

FIG. 5 shows a block diagram of a wireless device for selecting a polarization mode in a wireless communication system, in accordance with various aspects of the present disclosure;

FIG. 6 shows a call flow diagram illustrating communication in a wireless communication system, according to various aspects of the present disclosure;

FIGS. 7A-7C show diagrams of diversity schemes for communication in a wireless communication system according to various aspects of the present disclosure;

FIG. 8 shows a call flow diagram illustrating communication in a wireless communication system, according to various aspects of the present disclosure; and

FIGS. 9-12 show flowchart diagrams of illustrative methods for wireless communications, according to various aspects of the present disclosure.

### DETAILED DESCRIPTION

Addressing and reducing pathloss contributors improves communication efficiency and reliability. Pathloss in wireless communication systems may be a function of frequency, environmental factors, obstructions in the signal path, polarization mismatch, and the like. Pathloss impacts the received signal strength at the receiving end and, correspondingly, data reception and recovery. In high frequency systems (e.g., millimeter wave communication systems), such factors contribute to pathloss in varying degrees, i.e., some factors contribute more to pathloss as the frequency increases. Pathloss attributable to polarization mismatch may be a function of misaligned transmit and receive antennas, obstructions in the signal path, and the like. Therefore, there is a need for improved polarization matching to provide for higher signal gain and more reliable communications.

The described techniques and apparatuses enable a transmitter to select a polarization mode from polarization modes available for transmission. The polarization mode may be selected to provide for polarization matching and may reduce polarization related pathloss contributors. For example, the transmitter may select from among antennas having different polarizations to provide for polarization matching. The transmitter may send one or more transmissions (e.g., millimeter wave transmissions) using the selected polarization mode. The transmitter may receive feedback (initially and/or during transmissions) from a receiver indicative of the received signal strength, for example, and update the selected polarization mode in real time to ensure continued polarization matching. For example, path conditions may change during transmissions as the user moves along a route and, based on the received feedback, the polarization mode may be updated to account for such changes. The selected polarization modes may be implemented using time frequency diversity to further improve polarization matching.

Thus, the following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various steps may be added, omitted, or combined. Also, features described with respect to certain examples may be combined in other examples.

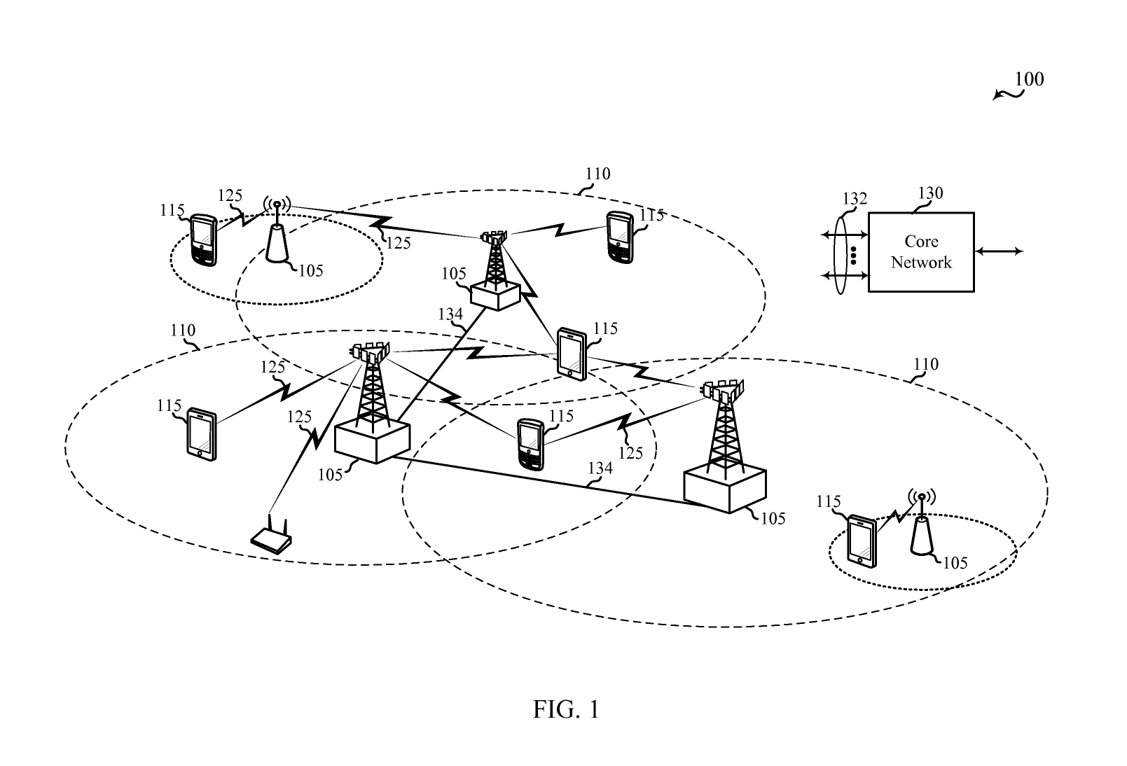

Referring first to FIG. 1, a diagram illustrates an example of a wireless communication system 100. The system 100 includes base stations (or cells or nodes) 105, user equipments (UEs) 115, and a core network 130. For the purposes of the present disclosure, the terms “cell,” “base station,” and “eNB” are used interchangeably. For the purposes of the present disclosure, the terms “UE” and “mobile device” are used interchangeably.

The base stations 105 may communicate with the UEs 115 under the control of a base station controller (not shown), which may be part of the core network 130 or the base stations 105 in various examples. Base stations 105 may communicate control information and/or user data with the core network 130 through backhaul 132. In certain examples, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communications link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the UEs 115 via one or more base station antennas. Each of the base stations 105 may provide communication coverage for a respective geographic coverage area 110. In some examples, a base station 105 may be referred to as a base transceiver station, a radio base station, an access point, a radio transceiver, a basic service set (BSS), an extended service set (ESS), a NodeB, eNodeB (eNB), a Home NodeB, a Home eNodeB, or some other suitable terminology. The coverage area 110 for a base station 105 may be divided into sectors making up only a portion of the coverage area (not shown). The system 100 may include base stations 105 of different types (e.g., macro, micro, and/or femto/pico base stations). There may be overlapping coverage areas for different technologies.

In certain examples, the system 100 is an LTE/LTE-A network. In LTE/LTE-A networks, the term evolved Node B (eNB) may be generally used to describe one or more of the base stations 105. The system 100 may be a Heterogeneous LTE/LTE-A network in which different types of eNBs provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the base stations 105 via a backhaul 132 (e.g., S1, etc.). The base stations 105 may also communicate with one another, e.g., directly or indirectly via backhaul links 134 (e.g., X2, etc.) and/or via backhaul 132 (e.g., through core network 130). The wireless communication system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communications links 125 shown in the wireless communication system 100 may include uplink (UL) transmissions from a UE 115 to a base station 105, and/or downlink (DL) transmissions from a base station 105 to a UE 115. The downlink transmissions may also be called forward link transmissions while the uplink transmissions may also be called reverse link transmissions.

The UEs 115 are dispersed throughout the wireless communication system 100 and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNBs, pico eNBs, femto eNBs, relays, and the like.

A UE 115 and/or a eNB 105 may be configured as a transmitter. The UE 115 and/or the eNB 105 may transmit information to other UEs 115 and/or eNBs 105 configured to act as receivers. The transmitter may select a polarization mode from polarization modes available for transmission. The polarization mode may be selected to align the electromagnetic wave with the polarization of the receive antennas to improve received signal strength. The transmitter may send transmission(s) based on the selected polarization mode. In some aspects, the transmitter may update the selected polarization mode based on feedback from a receiver receiving the transmission. For example, during an initial training event and/or during the transmissions, the receiver may send feedback (e.g., reference signal receive power, received signal strength indicator, etc.) indicative of the received signal strength. The transmitter may select and/or update the selected polarization mode based on the feedback. In the case of receiving feedback during the transmissions, the transmitter may updated the selected polarization mode in real time to account for changes at the receiver, in channel conditions, movement of path obstructers, etc.

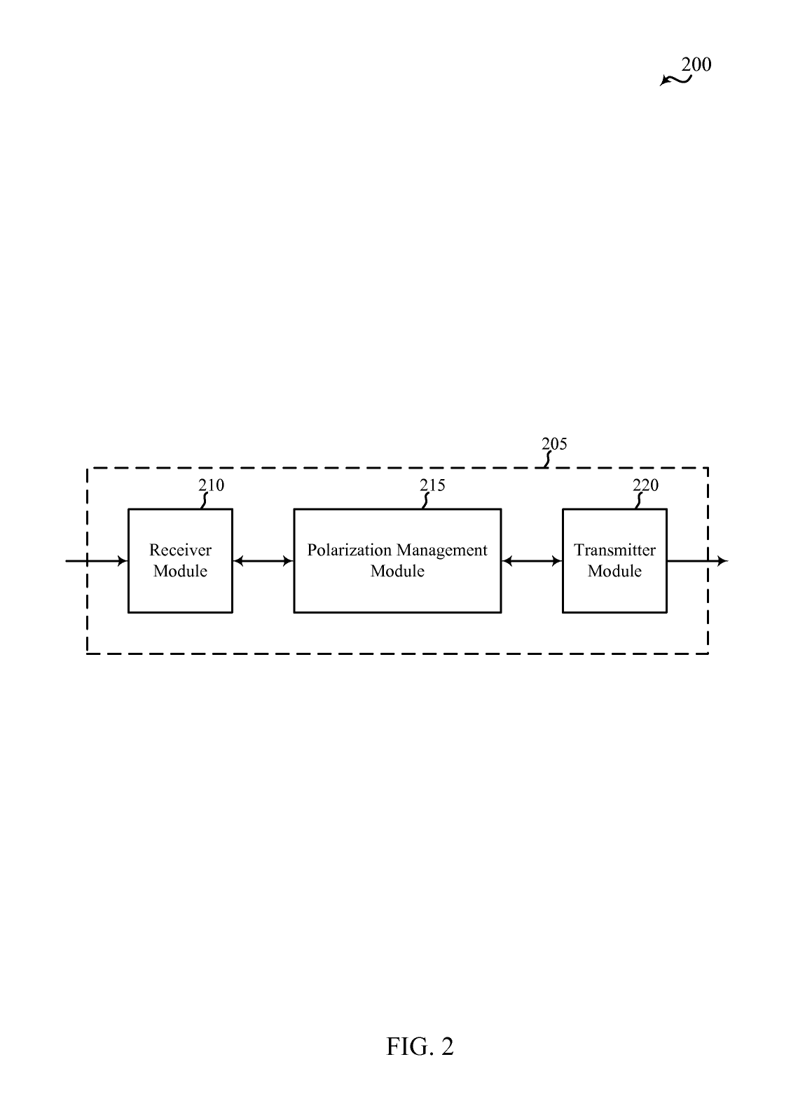

FIG. 2 shows a block diagram 200 of a wireless device 205 for determining polarization matching in a wireless communications system, in accordance with various aspects of the present disclosure. In some examples, the wireless device 205 may be an example of one or more aspects of the UEs 115 described with reference to FIG. 1. In other examples, the wireless device 205 may be an example of the eNB 105 described with reference to FIG. 1 The wireless device 205 may also be a processor. Generally, the wireless device 205 may be configured to optimize polarization matching in a wireless communication system. The wireless device 205 may include a receiver module 210, a polarization management module 215, and/or a transmitter module 220. Each of these components may be in communication with each other.

The components of the wireless device 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 210 may be, or include, a wireless receiver, such as a cellular receiver and/or a wireless local area network (WLAN) receiver. The receiver module 210 may also include more than one wireless receiver. The receiver module 210 may be used to receive various types of data and/or control signals (i.e., transmissions) over one or more communication links (e.g., channels) of one or more wireless communication systems, such as one or more communication links 125 of the wireless communication systems 100 described with reference to FIG. 1.

In some examples, the transmitter module 220 may be, or include, a wireless transmitter, such as a cellular transmitter and/or a WLAN transmitter. The transmitter module 220 may also include more than one wireless transmitter. The transmitter module 220 may be used to transmit various types of data and/or control signals (i.e., transmissions) over one or more communication links (e.g., channels) of one or more wireless communication systems, such as one or more communication links 125 of the wireless communication systems 100 described with reference to FIG. 1.

In some examples, the polarization management module 215 may be used to manage polarization selection and management for wireless communications of the wireless device 205. In some cases, the management of polarization selection may include selecting a polarization mode from among a plurality of polarization modes available for transmission to a receiver associated with the wireless device 205. The polarization management module 215 may communicate with the transmitter module 220 to send transmissions to receivers, the transmissions being based on the selected polarization mode.

In some aspects, the polarization management module 215 may access historical information associated with past communication performance to determine the polarization mode to select, e.g., historical information that indicates which polarization mode was used for successful communications at a similar day, time, location, mobility pattern, and the like. Some aspects may provide for updating the polarization mode based on feedback from the receiver. Other aspects may provide for using time and/or frequency diversity with respect to the selected polarization mode.

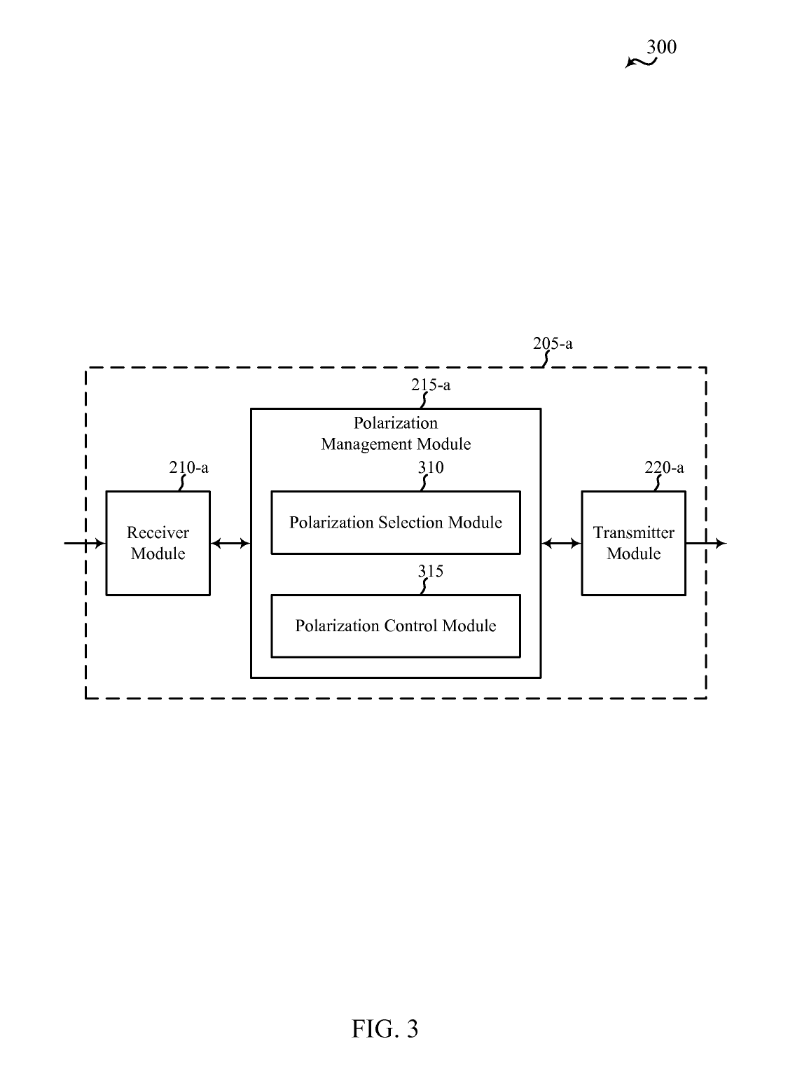

FIG. 3 shows a block diagram 300 of a wireless device 205-a for determining polarization matching in a wireless communications system, in accordance with various aspects of the present disclosure. In some examples, the wireless device 205-a may be an example of one or more aspects of the UEs 115 described with reference to FIG. 1. In other examples, the wireless device 205-a may be an example of the eNB 105 described with reference to FIG. 1 The wireless device 205-a may also be a processor. Generally, the wireless device 205-a may be configured to select a polarization mode and send transmission(s) to receivers based on the selected polarization mode. The wireless device 205-a may include a receiver module 210-a, a polarization management module 215-a, and/or a transmitter module 220-a. Each of these components may be in communication with each other.

The components of the wireless device 205-a may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 210-a and the transmitter module 220-a may be configured similarly to the receiver module 210 and the transmitter module 230 described with reference to FIG. 2.

In some examples, the polarization management module 215-a may be an example of the polarization management module 215 described with reference to FIG. 2 and may include a polarization selection module 310 and/or a polarization control module 315. Each of these components may be in communication with each other.

The polarization selection module 310 may generally be configured to select a polarization mode from among a plurality of polarization modes available for transmission. The polarization selection module 310 may select the polarization mode from an initial random polarization mode, based on historical information, based on feedback received from a receiver, and the like.

Generally, the polarization selection module 310 may select a polarization mode to match the polarization of the transmitted electromagnetic wave with respect to the receive antenna to achieve polarization optimization. It is to be understood, however, that polarization matching and optimization may not necessarily require parallel matching and alignment. Electromagnetic waves usually propagate in three modes: line of sight (LOS), reflection, and diffraction. If the electromagnetic waves propagate in the LOS mode (e.g., without interference from path obstructions), then the polarization of the electromagnetic wave relies on the transmitter and receiver using the same polarization for minimal pathloss. However, this is usually not the case in wireless communications, especially in higher frequency communication systems (e.g., millimeter wave frequencies) where the electromagnetic wave is susceptible to being blocked by human bodies, for example. Therefore, in many cases, the electromagnetic wave arriving at the receiver antenna has been subjected to reflection or diffraction. Regarding reflection, the reflected energy highly depends on the polarizations and the perpendicular polarization generally works better than parallel polarization. Moreover, for parallel polarization, when the incident angle reaches the Brewster's angle, then no energy would be reflected, which means that the link suffers maximum loss. Therefore, if the dominant path to the receiver antenna relies on reflection, then the polarization selection module 310 may select a polarization mode to achieve perpendicular polarization.

Similarly, diffraction also depends on the polarization of the electromagnetic wave arriving at the receiver antenna. With regards to diffraction, parallel polarization may result in smaller loss comparing with perpendicular polarization, e.g., 8 db for metal edge and 16 db for metal wedge. Therefore, if the dominant path to the receiver antenna relies on diffraction, then the polarization selection module 310 may select a polarization mode to achieve parallel polarization.

In some examples, the polarization selection module 310 may be configured to diversify a plurality of transmission signals into different polarizations to improve the robustness. The diversification may be implemented in the time and/or the frequency domain. For example, the polarization selection module 310 may be configured to sub-divide time frequency resources into a plurality of transmission opportunities (also referred to as sub-transmissions, fractions, transmission sub-blocks, or other suitable terminology). At least some of the transmission opportunities may have a different size (e.g., a different transmission time period, a different transmission frequency and/or band, and the like). The polarization selection module 310 may select a polarization mode for each transmission opportunity. For example, a first transmission opportunity occurring during a first transmission time period may use a first polarization mode, a second transmission opportunity occurring during a second transmission time period may use a second polarization mode, and so forth. As another example, a first, second, and third transmission band may be selected to occur during a first transmission period where each transmission band uses a different polarization mode.

In some examples, the polarization selection module 310 may adjust the size of one, some, and/or all of the transmission opportunities based at least in part on feedback received from a receiver receiving a transmission during one of the transmission opportunities. The feedback may include information indicative of the received signal strength of the transmission opportunities. For example, the polarization selection module 310 may adjust the transmission time period and/or the transmission band for the transmission opportunities.

In some examples, the polarization selection module 310 may be configured to select the polarization mode by accessing historical data associated with previous transmissions and selecting the polarization mode based at least in part on the historical data. The historical data may include information associated with received signal strength measurements for the previous transmissions. The previous transmission may be based on, and correlate to a current location of the transmitter, a current transmission day and/or time, a current mobility pattern of the transmitter, and the like.

The polarization control module 315 may control the polarization mode for the transmissions being transmitted from the wireless device 205-a. For example, the polarization control module 315 may cooperate with the transmitter module 220-a to select and/or otherwise control antennas transmitting the transmissions. In some cases, the wireless device 205-a may include more than one antenna, e.g., at least two pairs of antennas, used for transmitting signals. At least a portion of the antennas may have different orientations with respect to each other and therefore transmit electromagnetic waves at different polarization modes. In some examples, the polarization control module 315 may, alone or in cooperation with the transmitter module 220-a, may select and control multiple antennas having different orientations to transmit an electromagnetic wave at a particular polarization mode.

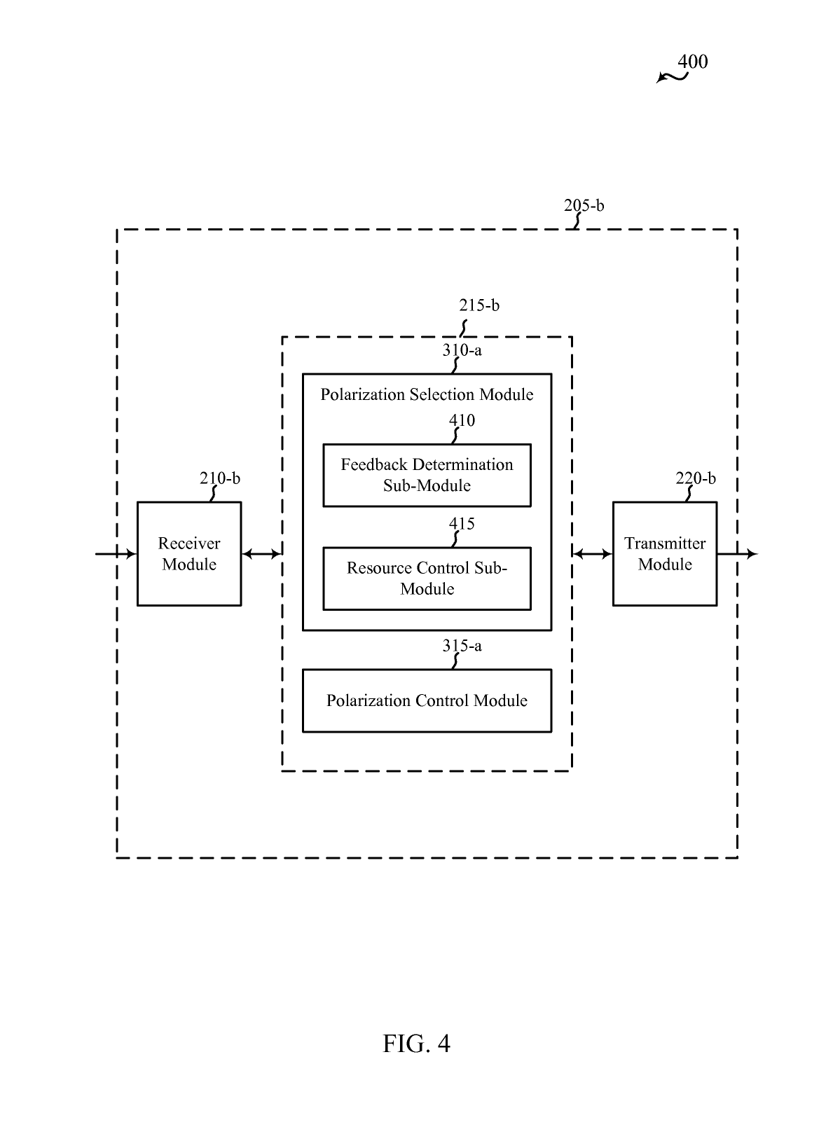

FIG. 4 shows a block diagram 400 of a wireless device 205-b for determining polarization optimization in a wireless communications system, in accordance with various aspects of the present disclosure. In some examples, the wireless device 205-b may be an example of one or more aspects of the UEs 115 described with reference to FIG. 1. In other examples, the wireless device 205-b may be an example of the eNB 105 described with reference to FIG. 1 The wireless device 205-b may also be a processor. Generally, the wireless device 205-c may be configured to select a polarization mode for transmissions to reduce pathloss due to polarization mismatch. The wireless device 205-b may include a receiver module 210-b, a polarization management module 215-b, and/or a transmitter module 220-b. Each of these components may be in communication with each other.

The components of the wireless device 205-b may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 210-b and the transmitter module 220-b may be configured similarly to the receiver module 210 and the transmitter module 220 described with reference to FIGS. 2 and/or 3.

In some examples, the polarization management module 215-b may be an example of the polarization management module 215 described with reference to FIGS. 2 and/or 3 and may include a polarization selection module 310-a and/or a polarization control module 315-a. Each of these components may be in communication with each other.

The polarization selection module 310-a may be an example of the polarization selection module 310 described above with reference to FIG. 3 and may include a feedback determination sub-module 410 and/or a resource control sub-module 415. The feedback determination sub-module 410 may be configured to communicate with the receiver module 210-b to determine whether a feedback signal has been received. The feedback determination sub-module 410 may provide information indicative of whether a feedback signal has been received. In some examples, the polarization selection module 310-a may be configured to perform a training session to select the polarization mode for transmissions. For example, the polarization selection module 310-a may communicate with the transmitter module 220-b to transmit a plurality of reference signals where each reference signal is transmitted at a different polarization mode. The polarization selection module 310-a may communicate with the receiver module 210-b to receive a response associated with one, some, and/or all of the transmitted reference signals. The feedback response may include information indicative of the received signal strength for the associated transmitted reference signal. Accordingly, the polarization selection module 310-a may select the polarization mode based on the received response for the associated transmitted reference signal. For example, the feedback response may indicate that polarization mode 1 is associated with the strongest received signal strength and, therefore, the polarization selection module 310-a may select polarization mode 1 for subsequent transmissions.

In some examples, the polarization selection module 310-a may be configured to receive feedback during transmissions and, based on the feedback, update the selected polarization mode in real time, i.e., as changing conditions alter that optimal signal path to the receive antennas. For example, the feedback determination sub-module 410 may communicate with the receiver module 210-b, for example, to determine if a feedback response is receive from at least one receiver receiving the transmissions from the transmitter module 220-b. If a feedback response signal is receive, the feedback determination sub-module 410 may decode the feedback response to determine the received signal strength for the receive based on the current polarization mode being used for transmissions. For example, the feedback determination sub-module 410 may determine if the received signal strength is below a threshold level, has been below a threshold level for a predetermined time period, has dropped below the threshold level a predetermined number of times, etc., and output information indicative of the received signal strength and/or whether the polarization mode needs to be updated. Accordingly, the polarization selection module 310-a may maintain the current polarization mode being used for transmissions or update the polarization mode based on the received feedback signal.

In some examples, the resource control sub-module 415 may be configured to control aspects of polarization mode selection of the wireless device 205-b. In some examples, the polarization selection module 310-a may be configured to diversify the polarization mode in the time and/or frequency domain. The resource control sub-module 415 may be configured to sub-divide a time resource and/or a frequency resource into transmission opportunities (or transmission sub-blocks). All, or at least some of the transmission opportunities may have a different size, e.g., a different transmission time period and/or a transmission band (or frequency). The polarization selection module 310-a may select a polarization mode that is different for each transmission opportunity to achieve time frequency diversity.

In some examples, the resource control sub-module 415 may communicate with the feedback determination sub-module 410 to determine whether a feedback signal (e.g., received signal strength) has been received from a receiver receiving the transmission opportunities. If a feedback signal has been received, the resource control sub-module 415 may adjust the size of the transmission opportunity to provide optimized polarization matching. For example, the resource control sub-module 415 may reduce or enlarge a transmission time period and/or a transmission band for a polarization mode based on the feedback.

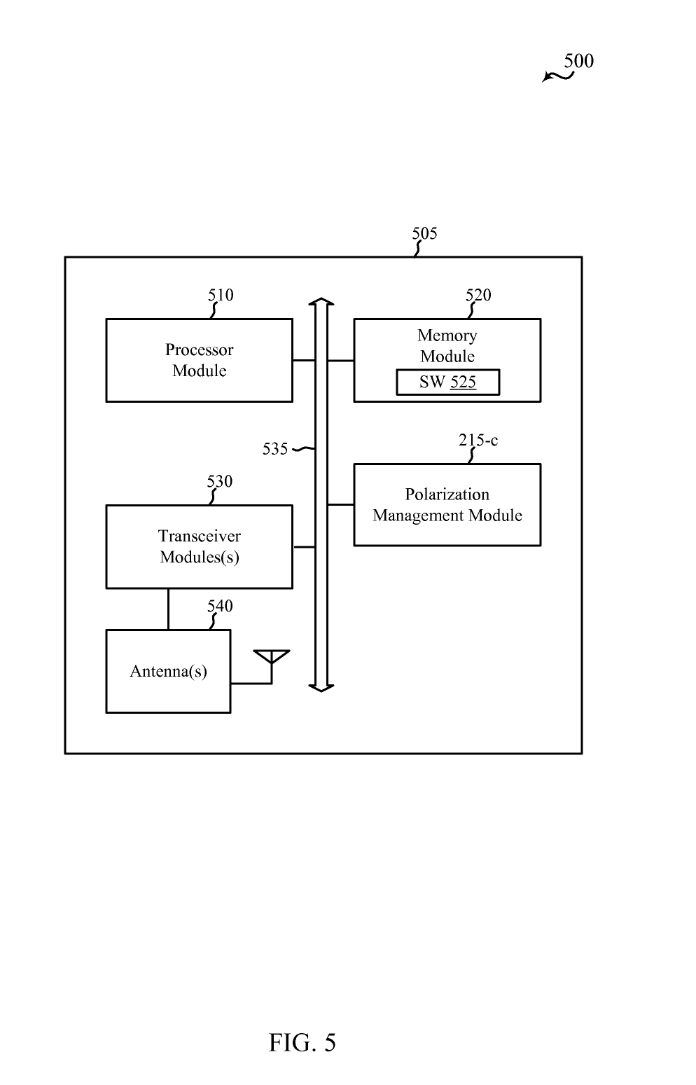

FIG. 5 shows a block diagram 500 of an apparatus 505 for determining polarization matching, in accordance with various aspects of the present disclosure. The apparatus 505 may have various configurations and may be included or be part of a personal computer (e.g., a laptop computer, netbook computer, tablet computer, etc.), a cellular telephone, a PDA, a digital video recorder (DVR), an internet appliance, a gaming console, an e-reader, an eNB, a base station, etc. The apparatus 505 may in some cases have an internal power supply (not shown), such as a small battery, to facilitate mobile operation. In some examples, the apparatus 505 may be an example of one or more aspects of one of the wireless devices 115 described with reference to FIG. 1 and/or the wireless devices 205 described with reference to FIG. 2, 3, or 4. The apparatus 505 may be configured to implement at least some of the features and functions described with reference to FIGS. 1, 2, 3, and/or 4. The apparatus 505 may be configured to communicate with one or more of the eNBs 105 and/or with one or more of the UEs 115 described with reference to FIG. 1.

The apparatus 505 may include a processor module 510, a memory module 520, at least one transceiver module (represented by transceiver module(s) 530), at least one antenna (represented by antenna(s) 540), and/or a polarization management module 215-c. Each of these components may be in communication with each other, directly or indirectly, over one or more buses 535.

The memory module 520 may include random access memory (RAM) and/or read-only memory (ROM). The memory module 520 may store computer-readable, computer-executable software (SW) code 525 containing instructions that are configured to, when executed, cause the processor module 510 to perform various functions described herein for selecting a polarization mode in a wireless communication system. Alternatively, the software code 525 may not be directly executable by the processor module 510 but be configured to cause the apparatus 505 (e.g., when compiled and executed) to perform various of the functions described herein.

The processor module 510 may include an intelligent hardware device, e.g., a CPU, a microcontroller, an ASIC, etc. The processor module 510 may process information received through the transceiver module(s) 530 and/or information to be sent to the transceiver module(s) 530 for transmission via the antenna(s) 540. The processor module 510 may handle, alone or in connection with the polarization management module 215-c, various aspects of selecting a wireless communication system.

The transceiver module(s) 530 may include a modem configured to modulate packets and provide the modulated packets to the antenna(s) 540 for transmission, and to demodulate packets received from the antenna(s) 540. The transceiver module(s) 530 may in some cases be implemented as one or more transmitter modules and one or more separate receiver modules. The transceiver module(s) 530 may be configured to communicate bi-directionally, via the antenna(s) 540, with one or more eNBs 105, UEs 115, or other devices. While the apparatus 505 may include a single antenna, there may be examples in which the apparatus 505 may include multiple antennas 540.

The polarization management module 215-c may be configured to perform and/or control some or all of the modules described with reference to FIGS. 2, 3, and/or 4 and related to wireless communication polarization mode selection for the apparatus 505. The polarization management module 215-c, or portions of it, may include a processor, and/or some or all of the functionality of the polarization management module 215-c may be performed by the processor module 510 and/or in connection with the processor module 510.

FIG. 6 is a call flow diagram 600 illustrating communication in a wireless communication system according to various examples. The diagram 600 may illustrate aspects of the system 100 described with reference to FIG. 1. The diagram 600 includes a transmitting device 205-d and a receiving devices 605. Generally, the diagram 600 illustrates a scenario where the transmitting device 205-d selects a polarization mode for transmissions sent to the receiving devices 605. Each of these may be examples of UEs 115 and/or eNBs 105 described above with respect to FIG. 1.

The transmitting device 205-d may select a polarization mode at 610. The polarization mode may be selected based on historical information, feedback received from a receiver, and the like. The polarization mode may be selected to match or align the orientation of electromagnetic waves sent from the transmitting device 205-d to antenna(s) of the receiving device 605. At 615, the transmitting device 205-d sends one or more transmissions to the receiving device 605 based on the selected polarization mode. The transmissions sent based on the polarization mode may be used to send control and/or data information to the receiving device 605. The transmissions may be millimeter wave transmissions.

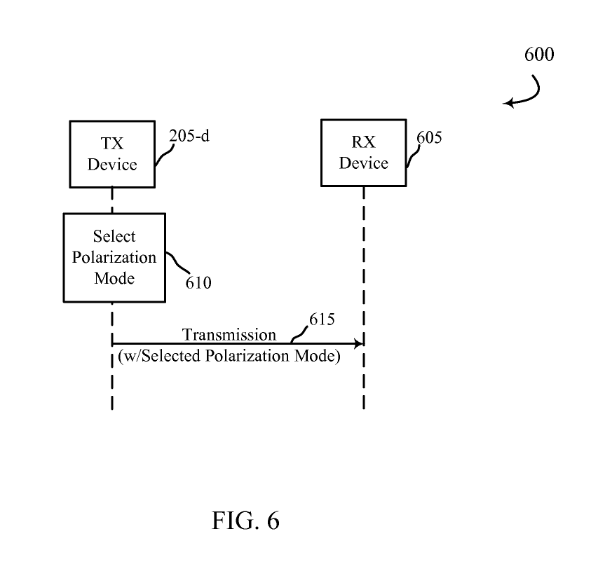

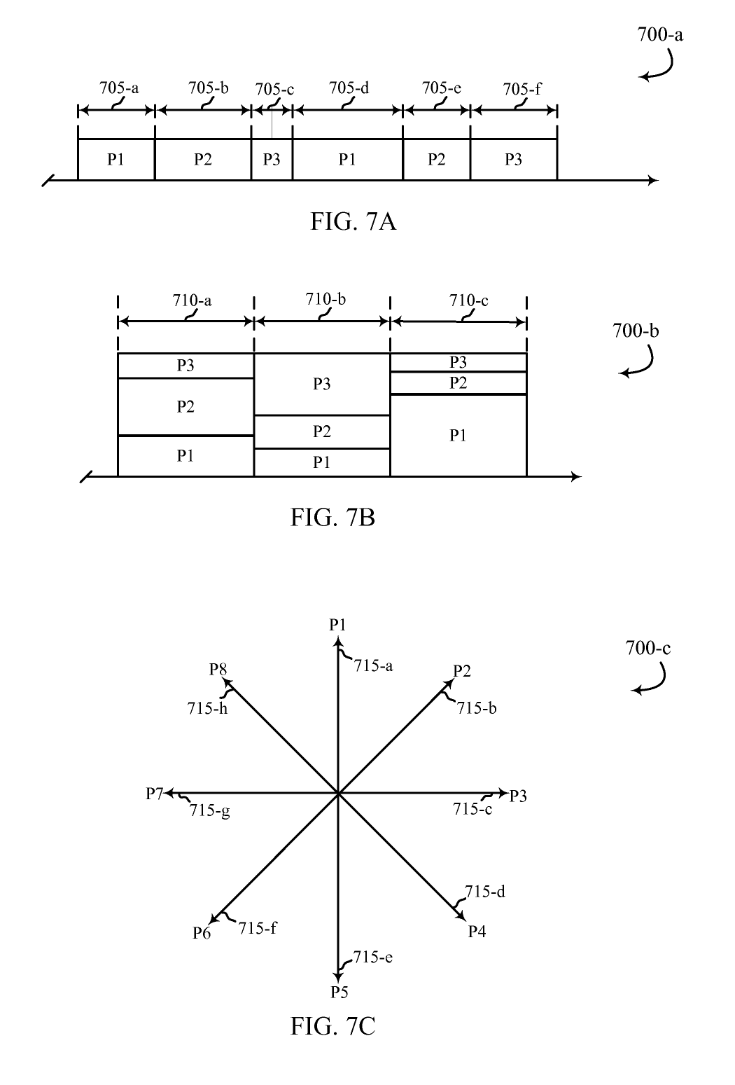

FIGS. 7A-7C show diagrams 700 of diversity schemes for polarization mode based communication in a wireless communication system according to various aspects of the present disclosure. Specifically, FIG. 7A shows a time diversity scheme, FIG. 7B shows a frequency diversity scheme, and FIG. 7C shows a polarization mode diversity scheme that may be employed based on the polarization mode selection functions described herein. For clarity, the diagrams 700 are described below with reference to aspects of one or more of the UEs 115, the devices 205, and/or the apparatus 505 described with reference to FIGS. 1, 2, 3, 4, 5, and/or 6. In some examples, a UE such as one of the UEs 115 may execute one or more sets of codes to control the functional elements to implement the diversity schemes described below. In other examples, a eNB such as one of the eNBs 105 may execute one or more sets of code to control the functional elements to implement the diversity schemes described below.

FIG. 7A shows a diversity scheme where the transmission signals based on the polarization mode are diversified into different polarizations for each transmit time period (or transmit opportunity). Generally, the polarization management module 215, for example, may split data transmission into fractions (also referred to as transmit opportunities), each of which uses one polarization (i.e., a different polarization mode) to transmit the data. Moreover, the size of the fractions may change overtime based on feedback from the receiver receiving the transmissions. For example, as shown in FIG. 7A, the first transmit opportunity 705-a may use a polarization mode P1, the second transmit opportunity 705-b may use a polarization mode P2, a third transmit opportunity 705-c may use a polarization mode P3, a fourth transmit opportunity 705-d may again use a polarization mode P1, and so on. Moreover, the size of each transmit opportunity 705 may be adjusted such that each has a different transmit time period. For example, as shown in FIG. 7A, transmit opportunity 705-c has a smaller transmit time period than transmit opportunity 705-d. Further, each transmit opportunity 705 for a particular polarization mode may have a different size, e.g., transmit opportunity 705-c is smaller than transmit opportunity 705-f, both of which are used to send transmissions based on polarization mode P3.

Although the time-based polarization mode diversity scheme of FIG. 7A is shown in a repeating manner (i.e., P1-P2-P3-P1-P2-P3), it is to be understood that other sequences may be selected in accordance with the described techniques to achieve time based diversity.

FIG. 7B shows a diversity scheme where the transmission signals based on the polarization mode are diversified into different polarization modes of different size for each transmit time period (or transmit opportunity). Generally, the polarization management module 215, for example, may split bandwidth into fractions, each of which may use one polarization mode to transmit the data. In some examples, a transmitter implementing the frequency-based diversity scheme may use multiple radio frequency chains for each selected polarization mode being transmitted during a transmit opportunity 710. Moreover, the fractions or size of each transmission band, as well as the transmit power assigned to each fraction may change over time depending on feedback signal from a receiver. For example, as shown in FIG. 7B, during the transmit opportunity 710-a, the selected polarization mode P2 uses a larger bandwidth with respect to the polarization modes P1 and P3. As another example, during the transmit opportunity 710-c, the selected polarization mode P1 uses a larger bandwidth with respect to polarization modes P2 and P3. The selection of the bandwidth for the particular polarization mode may be determined based on feedback signals received from a receiver.

Moreover, although FIG. 7B generally shows each transmit opportunity 710 as being the same transmit time period, it is to be understood that the period for each transmit opportunity 710 is also flexible in the sense that once the receiver is not satisfied with current bandwidth splitting, it can inform the transmitter via feedback signals and the transmitter can make adjustment accordingly. That is, the transmitter may implement the time diversity scheme of FIG. 7A and the frequency diversity scheme of FIG. 7B concurrently to achieve time frequency diversity where the bandwidth is divided among selected polarization modes and each polarization mode may be transmitted for a different transmit opportunity time period.

FIG. 7C shows a diversity scheme where the transmission signals based on the polarization mode are diversified into different polarization modes for each transmit time period (or transmit opportunity). Generally, the polarization management module 215, for example, may transmit circularly polarized waves in a repeating fashion. For example, as shown in FIG. 7C, the transmitter may transmit signals at a polarization mode P1, then a polarization mode P2, and so on, until it returns to transmit the polarization mode P1 again, thus restarting the circular pattern. In some aspects, the circular polarization mode diversity scheme may provide for a 3 db loss of signal strength at the receive antenna, as compared with matched polarization. On the receiver side, the loss due to circular polarization pattern may be averaged out to ensure data recovery.

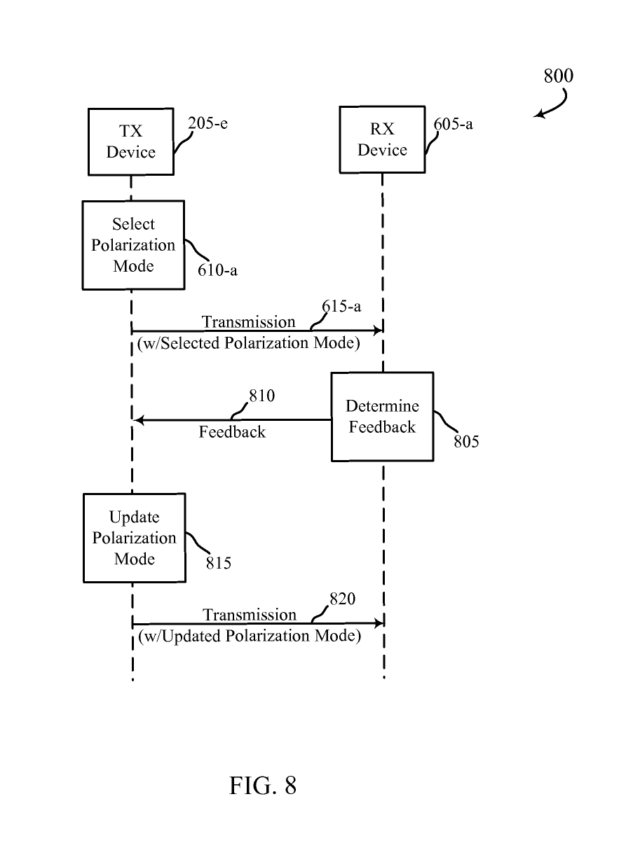

FIG. 8 is a call flow diagram 800 illustrating communication in a wireless communication system according to various examples. The diagram 800 may illustrate aspects of the system 100 described with reference to FIG. 1. The diagram 800 includes a transmitting device 205-e and a receiving devices 605. Generally, the diagram 800 illustrates a transmissions scenario where the transmitting device 205-e updates the selected polarization mode based on feedback signals received from the receiving devices 605. Each of these may be examples of UEs 115 and/or eNBs 105 described above with respect to FIG. 1.

The transmitting device 205-e may select a polarization mode at 610-a. The polarization mode may be selected based on historical information, for example. The polarization mode may be selected to match or align the orientation of electromagnetic waves sent from the transmitting device 205-e to antenna(s) of the receiving device 605-a. At 615-a, the transmitting device 205-d sends one or more transmissions to the receiving device 605 based on the selected polarization mode. At 805, the receiving device 605-a determines feedback for the received transmission and sends feedback signals to the transmitting device 205-e at 810. The feedback signal may include information indicative of the receiver signal strength of the received transmissions.

At 815, the transmitting device 205-e may update the selected polarization mode based on the received feedback signals. For example, if the feedback signals indicate that the transmissions are received below a threshold level, the transmitter may select a different polarization mode in order to improve the received signal strength at the receiver antenna. At 820, the transmitting device 205-e may send one or more transmissions to the receiving device 605-a based on the updated polarization mode. The transmissions may be millimeter wave transmissions.

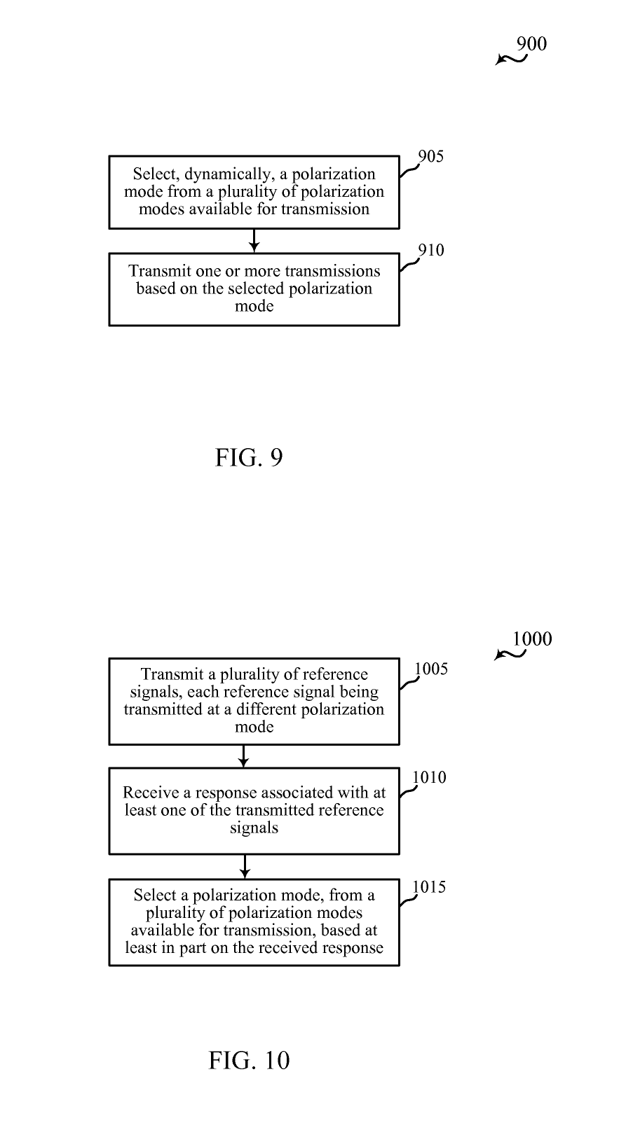

FIG. 9 is a flow chart illustrating an example of a method 900 for selecting a polarization mode in a wireless communication system, in accordance with various aspects of the present disclosure. For clarity, the method 900 is described below with reference to aspects of one or more of the UEs 115, the devices 205, and/or the apparatus 505 described with reference to FIGS. 1, 2, 3, 4, 5, 6, and/or 8. In some examples, a UE such as one of the UEs 115 may execute one or more sets of codes to control the functional elements to perform the functions described below. In other examples, a eNB such as one of the eNBs 105 may execute one or more sets of code to control the functional elements to perform the functions described below.

At block 905, a transmitter may dynamically select a polarization mode from among a plurality of polarization modes available for transmission. The operation(s) at block 905 may be performed by the polarization management module 215 described with reference to FIGS. 2, 3, 4, and/or 5.

The transmitter may dynamically select the polarization mode, i.e., without user intervention and/or instructions from another entity. The polarization mode may be selected to optimize polarization matching for electromagnetic waves and a receiver antenna. At block 910, one or more transmissions are transmitted based on the selected polarization mode, e.g., to a receiving device 605.

Thus, the method 900 may provide for selecting a polarization mode to ensure polarization matching. It should be noted that the method 900 is just one implementation and that the operations of the method 900 may be rearranged or otherwise modified such that other implementations are possible. In some examples, the operations at blocks 905 and 910 may be performed by the polarization management module 215 described with reference to FIGS. 2, 3, 4, and/or 5.

FIG. 10 is a flow chart illustrating an example of a method 1000 for selecting a polarization mode in a wireless communication system, in accordance with various aspects of the present disclosure. For clarity, the method 1000 is described below with reference to aspects of one or more of the UEs 115, the devices 205, and/or the apparatus 505 described with reference to FIGS. 1, 2, 3, 4, 5, 6, and/or 8. In some examples, a UE such as one of the UEs 115 may execute one or more sets of codes to control the functional elements to perform the functions described below. In other examples, a eNB such as one of the eNBs 105 may execute one or more sets of code to control the functional elements to perform the functions described below.

At block 1005, a transmitter transmits a plurality of reference signals, each reference signal having a different polarization mode. The transmitter may send the reference signals during a training session in an effort to ascertain which polarization mode is optimal for communicating with a receiver. The reference signal may be a pilot signal. At block 1010, a response to at least one of the reference signals is received. The response may be include information indicative of a received signal strength of the reference signal at the receiver. The response may be received if the received signal strength is below a threshold level, has been below the threshold level for a predetermined time period, has dropped below the threshold level a predetermined number of times within a time period, and the like.

At block 1015, a polarization mode is selected, from a plurality of polarization modes available for transmission, based at least in part on the received response. For example, the response may include feedback information indicating that a reference signal based on polarization mode P2 has the highest received signal strength. Accordingly, the polarization mode P2 may be selected for transmissions to achieve optimal polarization alignment.

Thus, the method 1000 may provide for selecting a polarization mode based on conducting a training session with a receiver. It should be noted that the method 1000 is just one implementation and that the operations of the method 1000 may be rearranged or otherwise modified such that other implementations are possible. In some examples, the operations at blocks 1005, 1010, and 1015 may be performed by the polarization management module 215 described with reference to FIGS. 2, 3, 4, and/or 5.

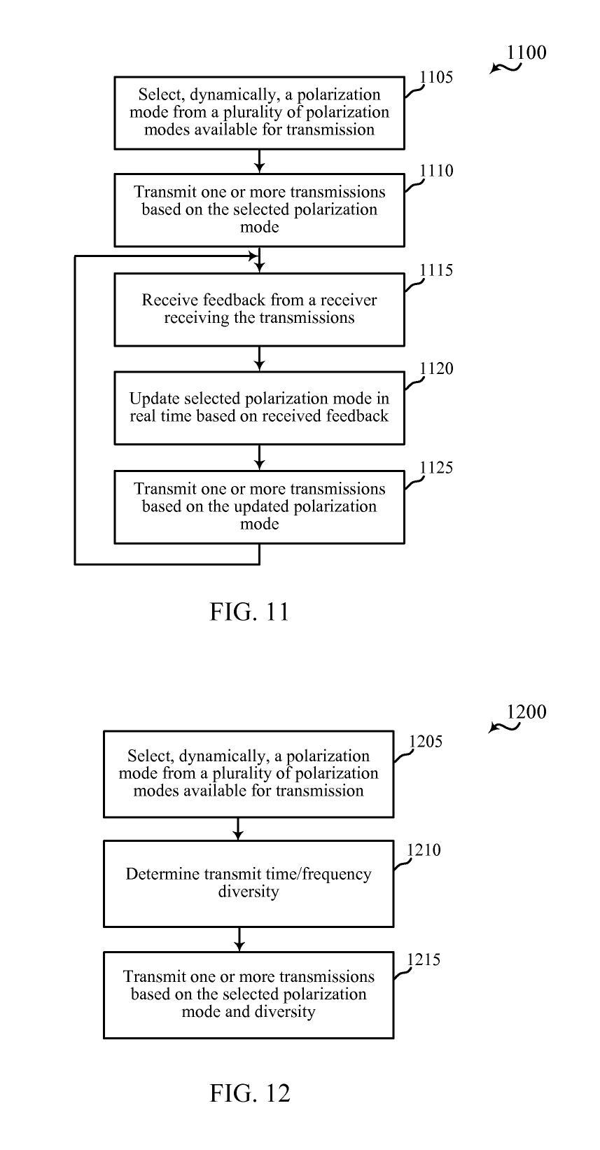

FIG. 11 is a flow chart illustrating an example of a method 1100 for selecting a polarization mode in a wireless communication system, in accordance with various aspects of the present disclosure. For clarity, the method 1100 is described below with reference to aspects of one or more of the UEs 115, the devices 205, and/or the apparatus 505 described with reference to FIGS. 1, 2, 3, 4, 5, 6, and/or 8. In some examples, a UE such as one of the UEs 115 may execute one or more sets of codes to control the functional elements to perform the functions described below. In other examples, a eNB such as one of the eNBs 105 may execute one or more sets of code to control the functional elements to perform the functions described below.

At block 1105, a transmitter dynamically selects a polarization mode from a plurality of polarization modes available for transmission. The polarization mode may be selected without user intervention and/or without receiving instructions to select the polarization mode from another entity. At block 1110, the transmitter transmits one or more transmissions based on the selected polarization mode. The transmissions are sent to a receiver associated with the transmitter and receiving the transmissions. At block 1115, feedback is received from a receiver receiving the transmissions. The feedback may include information indicative of the received signal strength of the transmissions.

At block 1120, the transmitter may updated the selected polarization mode in real time based on the received feedback. At block 1125, the transmitter transmits one or more transmissions based on the updated polarization mode. After block 1125, the method 1100 returns to block 1115 where additional feedback is received based on the transmissions and the polarization mode is again updated based on the additional feedback. For example, the transmitter may continually update the selected polarization mode during a data transmission session based on the feedback received from the receiver. As such, the transmitter may maintain optimal polarization alignment during changing conditions at the receiver/path.

Thus, the method 1100 may provide for updating a polarization mode selection in real time based on feedback received from a receiver. It should be noted that the method 1100 is just one implementation and that the operations of the method 1100 may be rearranged or otherwise modified such that other implementations are possible. In some examples, the operations at blocks 1105, 1110, 1115, 1120, and 1125 may be performed by the polarization management module 215 described with reference to FIGS. 2, 3, 4, and/or 5.

FIG. 12 is a flow chart illustrating an example of a method 1200 for selecting a polarization mode diversity scheme in a wireless communication system, in accordance with various aspects of the present disclosure. For clarity, the method 1200 is described below with reference to aspects of one or more of the UEs 115, the devices 205, and/or the apparatus 505 described with reference to FIGS. 1, 2, 3, 4, 5, 6, and/or 8. In some examples, a UE such as one of the UEs 115 may execute one or more sets of codes to control the functional elements to perform the functions described below. In other examples, a eNB such as one of the eNBs 105 may execute one or more sets of code to control the functional elements to perform the functions described below.

At block 1205, a transmitter may dynamically select a polarization mode from a plurality of polarization modes available for transmission. The polarization mode may generally be selected to optimize polarization alignment of electromagnetic waves at a receiver antenna in order to minimize pathloss attributable to polarization misalignment.

At block 1210, the transmitter determines transmit time diversity for the selected polarization mode. For example, any or all of the diversity schemes described with reference to FIGS. 7A, 7B, and/or 7C may be selected at block 1210. As discussed, the size of the time period of the transmit opportunity and/or the bandwidth for each polarization mode used for a transmit opportunity may be adjusted, independently, based on receiver feedback signals. The adjustments may be made in real time, i.e., during a data transmission session, based on receiver feedback.

At block 1215, the transmitter transmits one or more transmissions based on the selected polarization mode and time frequency diversity. The one or more transmissions may realize improved robustness based on the diversity scheme selected and the real time updating of the polarization mode and diversity scheme based on feedback.

Thus, the method 1200 may provide for selecting a polarization mode and accompanying diversity scheme for transmissions. It should be noted that the method 1200 is just one implementation and that the operations of the method 1200 may be rearranged or otherwise modified such that other implementations are possible. In some examples, the operations at blocks 1205, 1210, and 1215 may be performed by the polarization management module 215 described with reference to FIGS. 2, 3, 4, and/or 5.

The detailed description set forth above in connection with the appended drawings describes exemplary embodiments and does not represent the only examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communications, comprising:
transmitting a plurality of reference signals, each reference signal being transmitted at a different polarization mode;
receiving a response associated with at least one of the transmitted reference signals;
dynamically selecting a polarization mode from a plurality of polarization modes available for transmission based at least in part on the received response; and
transmitting one or more transmissions based on the selected polarization mode.

2. The method of claim 1, further comprising:
updating the selected polarization mode in real time based at least in part on feedback from a receiver receiving the transmissions.

3. The method of claim 1, wherein the received response comprises information indicative of a received signal strength for the associated transmitted reference signal.

4. The method of claim 1, wherein each of the plurality of transmitted reference signals are transmitted at a different transmit time.

5. The method of claim 1, wherein each of the plurality of transmitted reference signals are transmitted at a different transmit frequency.

6. The method of claim 1, wherein each of the plurality of transmitted reference signals are transmitted at a different transmit time and a different transmit frequency.

7. The method of claim 1, further comprising:
sub-dividing time frequency resources into a plurality of transmission opportunities, wherein at least a portion of the plurality of transmission opportunities are different size; and
selecting a polarization mode for each transmission opportunity.

8. The method of claim 7, further comprising:
adjusting the size of the plurality of transmission opportunities based at least in part on feedback received from a receiver receiving a transmission during one of the transmission opportunities, wherein the feedback comprises information indicative of the received signal strength of the transmission opportunities.

9. The method of claim 7, wherein the plurality of transmission opportunities comprise a portion of time, wherein the portion of time is a subset of the time frequency resources.

10. The method of claim 7, wherein the plurality of transmission opportunities comprise a portion of bandwidth, wherein the portion of bandwidth is a subset of the time frequency resources.

11. The method of claim 1, further comprising:
accessing historical data associated with previous transmissions; and
selecting the polarization mode based at least in part on the historical data.

12. The method of claim 11, wherein the historical data comprises information associated with received signal strength measurements for the previous transmissions.

13. The method of claim 1, wherein selecting the polarization mode comprises:
selecting a different polarization mode for each transmission such that the transmissions are transmitted in a circularly polarized scheme.

14. The method of claim 1, wherein the transmission is a millimeter wave transmission.

15. An apparatus for wireless communications, comprising:
a processor;
memory in electronic communication with the processor; and
instructions stored in the memory, the instructions being executable by the processor to:
transmit a plurality of reference signals, each reference signal being transmitted at a different polarization mode;
receive a response associated with at least one of the transmitted reference signals;
dynamically select a polarization mode from a plurality of polarization modes available for transmission based at least in part on the received response; and
transmit one or more transmissions based on the selected polarization mode.

16. The apparatus of claim 15, further comprising instructions executable by the processor to:
update the selected polarization mode in real time based at least in part on feedback from a receiver receiving the transmissions.

17. The apparatus of claim 15, wherein the received response comprises information indicative of a received signal strength for the associated transmitted reference signal.

18. The apparatus of claim 15, wherein each of the plurality of transmitted reference signals are transmitted at a different transmit time.

19. The apparatus of claim 15, wherein each of the plurality of transmitted reference signals are transmitted at a different transmit frequency.

20. The apparatus of claim 15, wherein each of the plurality of transmitted reference signals are transmitted at a different transmit time and a different transmit frequency.

21. The apparatus of claim 15, further comprising instructions executable by the processor to:
sub-divide time frequency resources into a plurality of transmission opportunities, wherein at least a portion of the plurality of transmission opportunities are different size; and
select a polarization mode for each transmission opportunity.

22. The apparatus of claim 21, further comprising instructions executable by the processor to:
adjust the size of the plurality of transmission opportunities based at least in part on feedback received from a receiver receiving a transmission during one of the transmission opportunities, wherein the feedback comprises information indicative of the received signal strength of the transmission opportunities.

23. The apparatus of claim 21, wherein the plurality of transmission opportunities comprise a portion of time, wherein the portion of time is a subset of the time frequency resources.

24. The apparatus of claim 21, wherein the plurality of transmission opportunities comprise a portion of bandwidth, wherein the portion of bandwidth is a subset of the time frequency resources.

25. The apparatus of claim 15, further comprising instructions executable by the processor to:
access historical data associated with previous transmissions; and
select the polarization mode based at least in part on the historical data.

26. The apparatus of claim 25, wherein the historical data comprises information associated with received signal strength measurements for the previous transmissions.

27. The apparatus of claim 15, wherein the instructions executable by the processor to select the polarization mode are further executable to:
select a different polarization mode for each transmission such that the transmissions are transmitted in a circularly polarized scheme.

28. The apparatus of claim 15, wherein the transmission is a millimeter wave transmission.

29. An apparatus for wireless communications, comprising:
means for transmitting a plurality of reference signals, each reference signal being transmitted at a different polarization mode;
means for receiving a response associated with at least one of the transmitted reference signals;
means for dynamically selecting a polarization mode from a plurality of polarization modes available for transmission based at least in part on the received response; and
means for transmitting one or more transmissions based on the selected polarization mode.

30. The apparatus of claim 29, further comprising:
means for updating the selected polarization mode in real time based at least in part on feedback from a receiver receiving the transmissions.

31. The apparatus of claim 29, wherein the received response comprises information indicative of a received signal strength for the associated transmitted reference signal.

32. The apparatus of claim 29, wherein each of the plurality of transmitted reference signals are transmitted at a different transmit time.

33. The apparatus of claim 29, wherein each of the plurality of transmitted reference signals are transmitted at a different transmit frequency.

34. The apparatus of claim 29, wherein each of the plurality of transmitted reference signals are transmitted at a different transmit time and a different transmit frequency.

35. The apparatus of claim 29, further comprising:
means for sub-dividing time frequency resources into a plurality of transmission opportunities, wherein at least a portion of the plurality of transmission opportunities are different size; and
means for selecting a polarization mode for each transmission opportunity.

36. The apparatus of claim 35, further comprising:
means for adjusting the size of the plurality of transmission opportunities based at least in part on feedback received from a receiver receiving a transmission during one of the transmission opportunities, wherein the feedback comprises information indicative of the received signal strength of the transmission opportunities.

37. The apparatus of claim 35, wherein the plurality of transmission opportunities comprise a portion of time, wherein the portion of time is a subset of the time frequency resources.

38. The apparatus of claim 35, wherein the plurality of transmission opportunities comprise a portion of bandwidth, wherein the portion of bandwidth is a subset of the time frequency resources.

39. The apparatus of claim 29, further comprising:
means for accessing historical data associated with previous transmissions; and
means for selecting the polarization mode based at least in part on the historical data.

40. The apparatus of claim 39, wherein the historical data comprises information associated with received signal strength measurements for the previous transmissions.

41. The apparatus of claim 29, wherein the means for selecting the polarization mode further comprises:
means for selecting a different polarization mode for each transmission such that the transmissions are transmitted in a circularly polarized scheme.

42. The apparatus of claim 29, wherein the transmission is a millimeter wave transmission.

43. A non-transitory computer-readable medium storing code for wireless communications, the code comprising instructions executable to:
transmit a plurality of reference signals, each reference signal being transmitted at a different polarization mode;
receive a response associated with at least one of the transmitted reference signals;
dynamically select a polarization mode from a plurality of polarization modes available for transmission based at least in part on the received response; and
transmit one or more transmissions based on the selected polarization mode.

44. The computer-readable medium of claim 43, further comprising instructions executable to:
update the selected polarization mode in real time based at least in part on feedback from a receiver receiving the transmissions.

45. The computer-readable medium of claim 43, wherein the received response comprises information indicative of a received signal strength for the associated transmitted reference signal.

46. The computer-readable medium of claim 43, wherein each of the plurality of transmitted reference signals are transmitted at a different transmit time.

47. The computer-readable medium of claim 43, wherein each of the plurality of transmitted reference signals are transmitted at a different transmit frequency.

48. The computer-readable medium of claim 43, wherein each of the plurality of transmitted reference signals are transmitted at a different transmit time and a different transmit frequency.

49. The computer-readable medium of claim 43, further comprising instructions executable to:
sub-divide time frequency resources into a plurality of transmission opportunities, wherein at least a portion of the plurality of transmission opportunities are different size; and
select a polarization mode for each transmission opportunity.

50. The computer-readable medium of claim 49, further comprising instructions to:
adjust the size of the plurality of transmission opportunities based at least in part on feedback received from a receiver receiving a transmission during one of the transmission opportunities, wherein the feedback comprises information indicative of the received signal strength of the transmission opportunities.

51. The computer-readable medium of claim 49, wherein the plurality of transmission opportunities comprise a portion of time, wherein the portion of time is a subset of the time frequency resources.

52. The computer-readable medium of claim 49, wherein the plurality of transmission opportunities comprise a portion of bandwidth, wherein the portion of bandwidth is a subset of the time frequency resources.

53. The computer-readable medium of claim 43, further comprising instructions to:
access historical data associated with previous transmissions; and
select the polarization mode based at least in part on the historical data.

54. The computer-readable medium of claim 53, wherein the historical data comprises information associated with received signal strength measurements for the previous transmissions.

55. The computer-readable medium of claim 43, wherein the instructions to select the polarization mode further comprise instructions to:
select a different polarization mode for each transmission such that the transmissions are transmitted in a circularly polarized scheme.

56. The computer-readable medium of claim 43, wherein the transmission is a millimeter wave transmission.
